(19) United States
(12) Patent Application Publication
(10) Pub. No.: US 2017/0171628 A1
(43) Pub. Date: Jun. 15, 2017

(54) METHOD AND ELECTRONIC DEVICE FOR QUICKLY PLAYING VIDEO

(71) Applicants: Le Holdings (Beijing) Co., Ltd., Beijing (CN); LE SHI INTERNET INFORMATION & TECHNOLOGY CORP.BEIJING, Beijing (CN)

(72) Inventor: Bing LIU, Beijing (CN)

(21) Appl. No.: 15/250,647

(22) Filed: Aug. 29, 2016

Related U.S. Application Data
(63) Continuation of application No. PCT/CN2016/089053, filed on Jul. 7, 2016.

(30) Foreign Application Priority Data
Dec. 15, 2015 (CN) 201510939501.0

(51) Int. Cl. H04N 21/472; G06K 7/14; H04N 21/478; G06K 19/06

(52) U.S. Cl. CPC H04N 21/47202; G06K 19/06037; G06K 7/1417; H04N 21/47815

(57) ABSTRACT

Disclosed are a method and an electronic device for quickly playing a video. The method includes: at an electronic device, generating a plurality of different authority packages according to video content previewed by a video viewer with no membership authority, and acquiring an authority package currently selected by the video viewer with no membership authority; and continuously playing video content previously previewed by the video viewer with no membership authority according to a message of successful payment for the selected authority package at the background.

### CROSS REFERENCE TO RELATED APPLICATIONS

This present disclosure is a continuation of International Application No. PCT/CN2016/089053, filed on Jul. 7, 2016, which is based upon and claims priority to Chinese Patent Application No. 201510939501.0, filed on Dec. 15, 2015, the entire contents of which are incorporated herein by reference.

### TECHNICAL FIELD

The present disclosure relates to the technical field of videos, and more particularly, to a method and an electronic device for quickly playing video.

### BACKGROUND

At present, users conducts payments in mainly two manners. One is subscribing for the membership services, and by means of month-based payment, season-based payment and year-based payment, users may watch video having a high-definition frame quality without advertisement, and may enjoy the function of watching more films. The other is on-demand content-based payment, and some hot films are provided.

However, when users who do not subscribe for the membership watch video content provided for users who subscribe for the membership, due to lack of the authority of the membership, these users may only watch a short section of video content for free, and fail to normally watch the entire video content. These users can continue watching the video content if they pay for the membership and becomes a member or log into the video websites via member accounts. Upon successful payment for the membership, the users generally need to search again for previously watched videos, and then manually jump to an time node provided for free watching previously.

### SUMMARY

The embodiments of the present disclosure employ the following technical solutions:

An embodiment of the present disclosure provides a method for quickly playing a video, including: at an electronic device, generating a plurality of different authority packages according to video content previewed by a video viewer with no membership authority, and acquiring an authority package currently selected by the video viewer with no membership authority; and continuously playing video content previously previewed by the video viewer with no membership authority according to a message of successful payment for the selected authority package at the background.

An embodiment of the present disclosure provides an electronic device for quickly playing a video, including: at least one processor; and a memory; wherein, the memory is communicably connected with the at least one processor and for storing instructions executed by the at least one processor, the computer executable instructions are configured to perform any one of the method for quickly playing a video described above in the disclosure.

An embodiment of the present disclosure further provides a non-transitory computer-readable storage medium storing executable instructions that, when executed by an electronic device, cause the electronic device to perform any one of the method for quickly playing a video described above in the disclosure.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic flowchart illustrating a method for quickly playing a video according to Embodiment 1 of the present disclosure;

FIG. 2 is a schematic flowchart illustrating step S101 according to Embodiment 2 of the present disclosure;

FIG. 3 is a schematic flowchart illustrating a method for quickly playing a video according to Embodiment 3 of the present disclosure;

FIG. 4 is a schematic flowchart illustrating step S302 according to Embodiment 2 of the present disclosure;

FIG. 5 is a schematic flowchart illustrating step S303 according to Embodiment 5 of the present disclosure;

FIG. 6 is a schematic structural diagram illustrating an apparatus for quickly playing a video according to Embodiment 6 of the present disclosure;

FIG. 7 is a schematic structural diagram of a authority package module according to Embodiment 7 of the present disclosure;

FIG. 8 is a schematic structural diagram illustrating an apparatus for quickly playing a video according to Embodiment 8 of the present disclosure;

FIG. 9 is a block diagram of an electronic device used to perform the method for quickly playing video according to an embodiment of the present disclosure.

### DETAILED DESCRIPTION

To make the objectives, technical solutions and advantages of the embodiments of the present disclosure clearer, the technical solutions according to the embodiments of the present disclosure are clearly and thoroughly described with reference to the accompanying drawings of the embodiments of the present disclosure. The described embodiments are merely exemplary ones, but are not all the embodiments of the present disclosure. Based on the embodiments of the present disclosure, all other embodiments derived by persons of ordinary skill in the art without any creative efforts shall fall within the protection scope of the present disclosure.

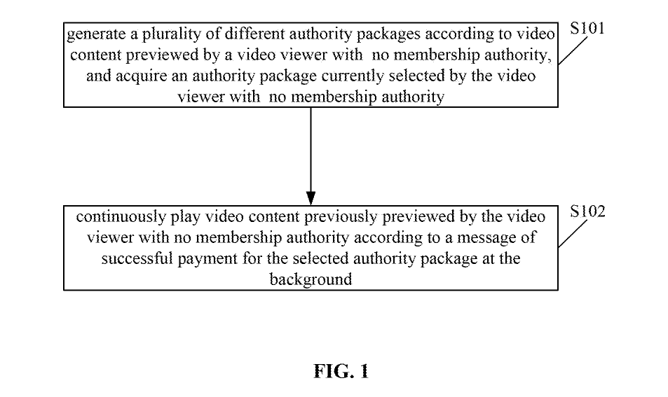

FIG. 1 is a schematic flowchart illustrating a method for quickly playing a video according to Embodiment 1 of the present disclosure. As illustrated in FIG. 1, the method includes the following steps:

In step S101: A plurality of different authority packages are generated according to video content previewed by a video viewer with no membership authority, and an authority package currently selected by the video viewer with no membership authority is acquired.

In this embodiment, the video may be specifically a film, a record, a sports event or the like, which may be live broadcast content or recorded convent.

In this embodiment, the previewed video content may be defined by setting a preview end time or preview count end value.

In this embodiment, for ease of subsequent quick payment, different authority packages are visually displayed on a display webpage of the smart terminal in the form of two-dimensional codes. That is, each type of package corresponds to a two-dimensional code.

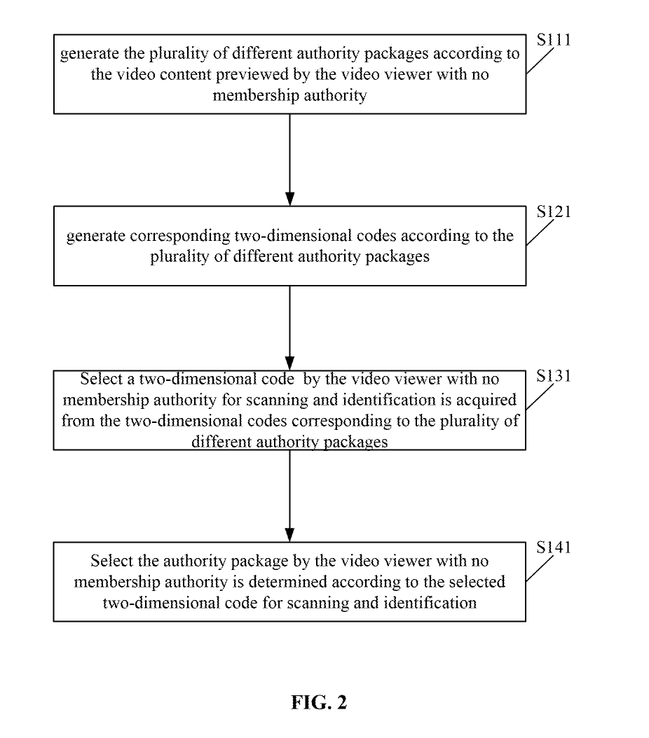

Therefore, specifically in this embodiment, the generating a plurality of different authority packages according to video content previewed by a video viewer with no membership authority may include steps S111, S121, S131 and S141. FIG. 2 is a schematic flowchart illustrating step S101 according to Embodiment 2 of the present disclosure. As illustrated in FIG. 2, the method may specifically include the following steps:

In step S111: The plurality of different authority packages are generated according to the video content previewed by the video viewer with no membership authority.

In step S121: Corresponding two-dimensional codes are generated according to the plurality of different authority packages.

In this embodiment, the generating corresponding two-dimensional codes according to the plurality of different authority packages in step S121 includes: promoting to generate the corresponding two-dimensional codes according to the plurality of different authority packages.

In step S131: A two-dimensional code selected by the video viewer with no membership authority for scanning and identification is acquired from the two-dimensional codes corresponding to the plurality of different authority packages.

In step S141: The authority package selected by the video viewer with no membership authority is determined according to the selected two-dimensional code for scanning and identification.

The identity of the video viewer may be directly identified according to a payment account or account information of the video viewer. Therefore, in this embodiment, in addition to the corresponding authority packages, the corresponding two-dimensional codes generated according to the plurality of different authority packages include payment account information of the video viewer with no membership authority, including payment amount, payment account and the like information.

In this embodiment, after the two-dimensional code is scanned, the specific information, for example, payment amount, authority range and the like of the authority package may be displayed for user's reference.

In step S102: Previously previewed video content is continuously played for the video viewer with no membership authority according to a message indicative of successful payment for the selected authority package at the background.

In this embodiment, the continuously playing video content previously previewed by the video viewer with no membership authority according to a message indicative of successful payment for the selected authority package at the background in step S102 may specifically include: continuously playing the previously previewed video content for the video viewer with no membership authority according to a message indicative of successful payment for the selected authority package at a cash register on an HTML5 webpage.

In this embodiment, a cash register configured based on the HTML5 webpage is set on a PC. It should be noted that under teachings of the embodiment of the present disclosure, a cash register interface may also be generated based on other text markup languages, which is not described herein any further.

In addition, if a cash register is set on a smart terminal, the cash register may also be configured based on a text markup language of an Android or iOS system, which is not described herein any further.

In this embodiment, steps S101 and S102 may be performed locally on the smart terminal, or may be performed at the background.

It should be noted that although the authority package is described in this embodiment using the two-dimensional code as an example, other implementation means may also be used. For example, code of the authority package and detailed information of the authority package may be directly displayed in another interface.

FIG. 3 is a schematic flowchart illustrating a method for quickly playing a video according to Embodiment 3 of the present disclosure. As illustrated in FIG. 3, the method includes the following steps:

In step S301: A time node when playing of the previewed video content stops is recorded, to continuously play the previously previewed video content for the video viewer with no membership authority at current time.

In step S302: The plurality of different authority packages are generated according to the video content previewed by the video viewer with no membership authority.

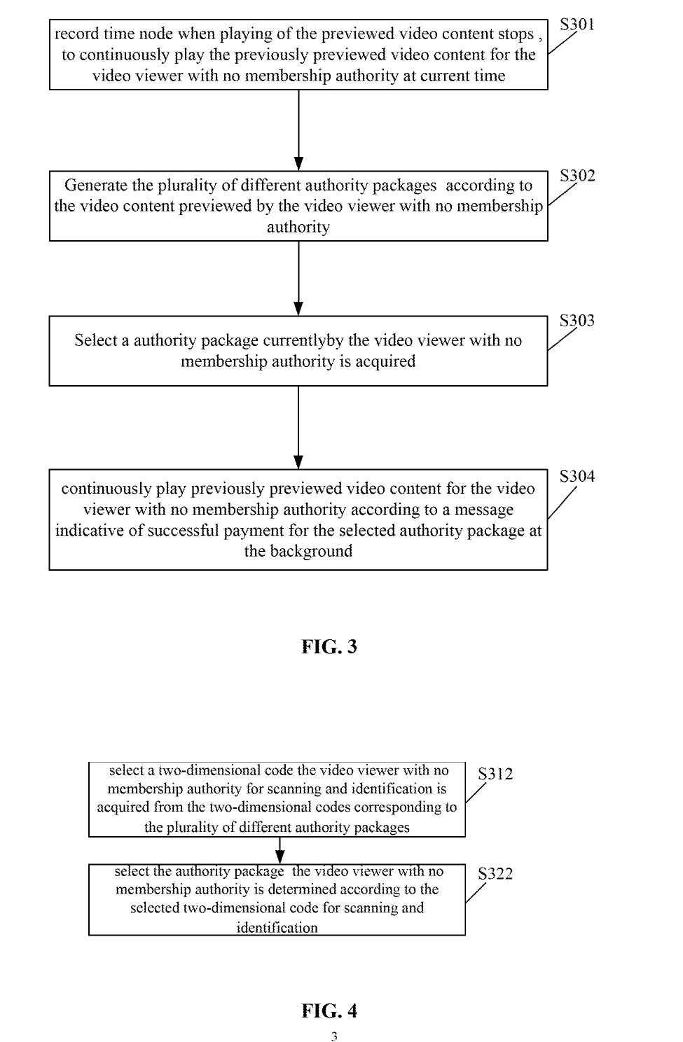

In this embodiment, the generating the he plurality of different authority packages according to the video content previewed by the video viewer with no membership authority in step S302 may include steps S312 and S322. FIG. 4 is a schematic flowchart illustrating step S302 according to Embodiment 4 of the present disclosure. As illustrated in FIG. 4, the method may specifically include the following steps:

In step S312: The plurality of different authority packages are generated according to the video content previewed by the video viewer with no membership authority.

In step S322: Corresponding two-dimensional codes are generated according to the plurality of different authority packages. Specifically, in this embodiment, the generating corresponding two-dimensional codes according to the plurality of different authority packages may include: promoting to generate the corresponding two-dimensional codes according to the plurality of different authority packages.

In step S303: An authority package currently selected by the video viewer with no membership authority is acquired.

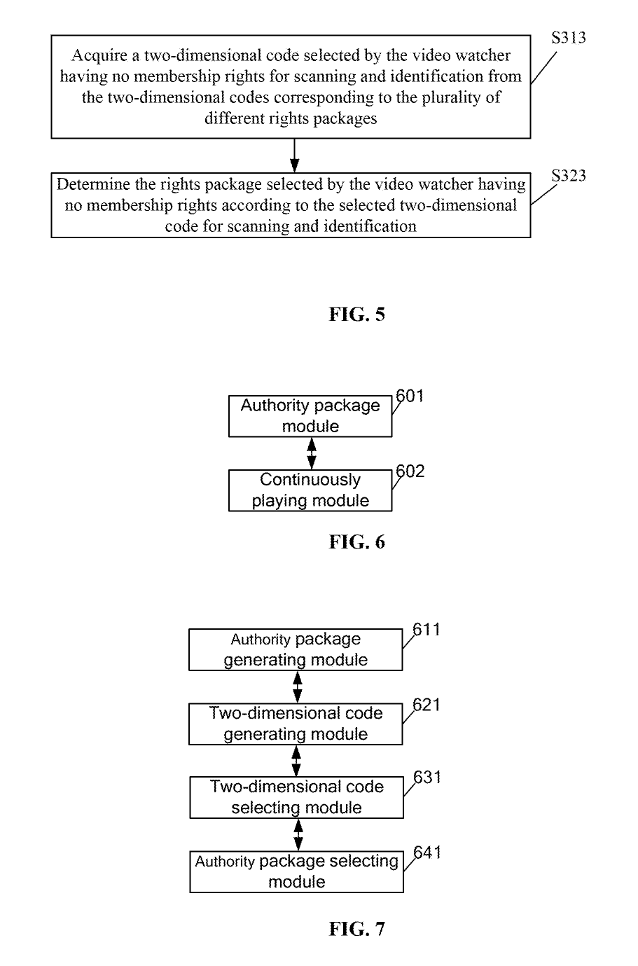

In this embodiment, the acquiring an authority package currently selected by the video viewer with no membership authority in step S303 may include steps S313 and S323. FIG. 5 is a schematic flowchart illustrating step S302 according to Embodiment 5 of the present disclosure. As illustrated in FIG. 5, the method may specifically include the following steps:

In step S313: A two-dimensional code selected by the video viewer with no membership authority for scanning and identification is acquired from the two-dimensional codes corresponding to the plurality of different authority packages.

In step S323: The authority package selected by the video viewer with no membership authority is determined according to the selected two-dimensional code for scanning and identification.

In this embodiment, the corresponding two-dimensional codes generated according to the plurality of different authority packages include payment account information of the video viewer with no membership authority.

In step S304: Previously previewed video content is continuously played for the video viewer with no membership authority according to a message indicative of successful payment for the selected authority package at the background.

In this embodiment, the continuously playing video content previously previewed by the video viewer with no membership authority according to a message indicative of successful payment for the selected authority package at the background in step S304 may specifically include steps: video content previously previewed by the video viewer with no membership authority is played continuously according to a message indicative of successful payment for the selected authority package at a cash register on an HTML5 webpage.

In this embodiment, a cash register configured based on the HTML5 webpage is set on a PC. It should be noted that under teachings of the embodiment of the present disclosure, a cash register interface may also be generated based on other techniques, which is not described herein any further.

In addition, if a cash register is set on a smart terminal, the cash register may also be configured based an Android or IOS system, which is not described herein any further.

Embodiments of the present disclosure further provides a non-transitory computer-readable storage medium storing executable instructions that, when executed by an electronic device with a touch-sensitive display, cause the electronic device to perform any of the embodiments described above of the method for quickly playing a video.

FIG. 6 is a schematic structural diagram illustrating an apparatus for quickly playing a video according to Embodiment 6 of the present disclosure. As illustrated in FIG. 6, the apparatus includes:

an authority package module 601 generates a plurality of different authority packages according to video content previewed by a video viewer with no membership authority, and acquire an authority package currently selected by the video viewer with no membership authority; and

a continuously playing module 602 continuously plays previously previewed video content for the video viewer with no membership authority according to a message indicative of successful payment for the selected authority package at the background.

In this embodiment, the authority package module 601 may include: an authority package generating module 611, a two-dimensional generating module 621, a two-dimensional selecting module 631 and an authority package selecting module 641. FIG. 7 is a schematic structural diagram illustrating an authority package module according to a seventh embodiment of the present disclosure. As illustrated in FIG. 7, the authority package module includes:

an authority package generating module 611 generates the plurality of different authority packages according to the video content previewed by the video viewer with no membership authority;

a two-dimensional code generating module 621 generates corresponding two-dimensional codes according to the plurality of different authority packages; specifically, in this embodiment, the two-dimensional generating module is configured to promote to generate the corresponding two-dimensional codes according to the plurality of different authority packages; in this embodiment, the corresponding two-dimensional codes generated according to the plurality of different authority packages include payment account information of the video viewer with no membership authority;

a two-dimensional code selecting module 631 acquires a two-dimensional code selected by the video viewer with no membership authority for scanning and identification from the two-dimensional codes corresponding to the plurality of different authority packages;

an authority package selecting module 641 determines the authority package selected by the video viewer with no membership authority according to the selected two-dimensional code for scanning and identification.

Specifically, in an embodiment of the present disclosure, the continuously playing module 602 is further configured to continuously play the previously previewed video content for the video viewer with no membership authority according to a message indicative of successful payment for the selected authority package at a cash register on an HTML5 webpage.

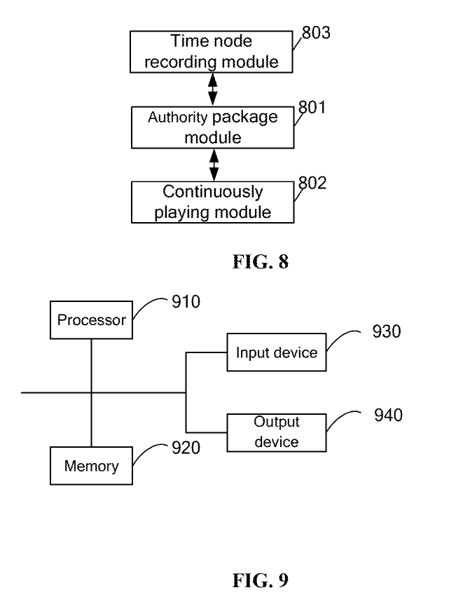

FIG. 8 is a schematic structural diagram illustrating an apparatus for quickly playing a video according to Embodiment 8 of the present disclosure. As illustrated in FIG. 8, the apparatus includes:

an authority package module 801 generates a plurality of different authority packages according to video content previewed by a video viewer with no membership authority, and acquire an authority package currently selected by the video viewer with no membership authority; and

a continuously playing module 802 continuously plays previously previewed video content for the video viewer with no membership authority according to a message indicative of successful payment for the selected authority package at the background.

In this embodiment, the authority package module 801 and the continuously playing module 802 are similar to the authority package module 601 and the continuously playing module 602, which are thus not described herein any further.

In this embodiment, the apparatus further includes: a recording module 803, configured to record a time node when playing of the previewed video content stops, to continuously play the previously previewed video content for the video viewer with no membership authority at current time.

FIG. 9 is a schematic diagram of hardware structure of an electronic device used to perform the method for quickly playing video according to an embodiment of the present disclosure, as shown in FIG. 9, the device includes:

One or more processors 910 and a memory 920, FIG. 9 illustrates one processor 910 as an example.

The device for the method for quickly playing video may further include an input device 930 and an output device 940.

The processor 910 the memory 920, the input device 930 and the output device 940 may be connected with each other through bus or other forms of connections. FIG. 9 illustrates bus connection as an example.

As a non-volatile computer-readable storage medium, the memory 920 may be configured to store non-volatile software program, non-volatile computer executable program and modules, such as program instructions/modules corresponding to the method for quickly playing video according to the embodiments of the disclosure (for example, the authority package module 601 and the continuously playing module 602, as illustrated in FIG. 6. By executing the non-volatile software program, instructions and modules stored in the memory 920, the processor 910 may perform various functional disclosures of the server and data processing, that is, the method for quickly playing video according to the above mentioned embodiments.

The memory 920 may include a program storage area and a data storage area, wherein, the program storage area may be stored with the operating system and disclosures which are needed by at least one functions, and the data storage area may be stored with data which is created according to use of the device for quickly playing video. Further, the memory 920 may include a high-speed random access memory, and may further include non-volatile memory, such as at least one of disk memory device, flash memory device or other types of non-volatile solid state memory device. In some embodiments, optionally, the memory 920 may include memory provided remotely from the processor 910, and such remote memory may be connected with the device for quickly playing video through network connections, the examples of the network connections may include but not limited to internet, intranet, LAN (Local Area Network), mobile communication network or combinations thereof.

The input device 930 may receive inputted number or character information, and generate key signal input related to the user settings and functional control of the device for quickly playing video. The output device 940 may include a display device such as a display screen.

The above one or more modules may be stored in the memory 920, when these modules are executed by the one or more processors 910, the method for quickly playing video according to any one of the above mentioned method embodiments may be performed.

The above product may perform the methods provided in the embodiments of the disclosure, include functional modules corresponding to these methods and advantageous effects. Further technical details which are not described in detail in the present embodiment may refer to the method provided according to embodiments of the disclosure.

The electronic device in the embodiment of the present disclosure exists in various forms, including but not limited to:

(1) mobile communication device, characterized in having a function of mobile communication mainly aimed at providing speech and data communication, wherein such terminal includes: smart phone (such as iPhone), multimedia phone, functional phone, low end phone and the like;

(2) ultra mobile personal computer device, which falls in a scope of personal computer, has functions of calculation and processing, and generally has characteristics of mobile internet access, wherein such terminal includes: PDA, MID and UMPC devices, such as iPad;

(3) portable entertainment device, which can display and play multimedia contents, and includes audio or video player (such as iPod), portable game console, E-book and smart toys and portable vehicle navigation device;

(4) server, an device for providing computing service, constituted by processor, hard disc, internal memory, system bus, and the like, which has a framework similar to that of a computer, but is demanded for superior processing ability, stability, reliability, security, extendibility and manageability due to that high reliable services are desired; and

(5) other electronic devices having a function of data interaction.

The above mentioned examples for the device are merely exemplary, wherein the unit illustrated as a separated component may be or may not be physically separated, the component illustrated as a unit may be or may not be a physical unit, in other words, may be either disposed in some place or distributed to a plurality of network units. All or part of modules may be selected as actually required to realize the objects of the present disclosure. Such selection may be understood and implemented by ordinary skill in the art without creative work.

According to the description in connection with the above embodiments, it can be clearly understood by ordinary skill in the art that various embodiments can be realized by means of software in combination with necessary universal hardware platform, and certainly, may further be realized by means of hardware. Based on such understanding, the above technical solutions in substance or the part thereof that makes a contribution to the prior art may be embodied in a form of a software product which can be stored in a computer-readable storage medium, such as ROM/RAM, magnetic disk and compact disc, and includes several instructions for allowing a computer device (which may be a personal computer, a server, a network device or the like) to execute the methods described in various embodiments or some parts thereof.

Finally, it should be stated that, the above embodiments are merely used for illustrating the technical solutions of the present disclosure, rather than limiting them. Although the present disclosure has been illustrated in details in reference to the above embodiments, it should be understood by ordinary skill in the art that some modifications can be made to the technical solutions of the above embodiments, or part of technical features can be substituted with equivalents thereof. Such modifications and substitutions do not cause the corresponding technical features to depart in substance from the spirit and scope of the technical solutions of various embodiments of the present disclosure.

What is claimed is:

1. A method for quickly playing a video, comprising: at an electronic device,
generating a plurality of different authority packages according to video content previewed by a video viewer with no membership authority, and acquiring an authority package currently selected by the video viewer with no membership authority; and
continuously playing video content previously previewed by the video viewer with no membership authority according to a message of successful payment for the selected authority package at the background.

2. The method according to claim 1, wherein the generating the plurality of different authority packages according to video content previewed by the video viewer with no membership authority comprises:
generating the plurality of different authority packages according to the video content previewed by the video viewer with no membership authority; and
generating corresponding two-dimensional codes according to the plurality of different authority packages.

3. The method according to claim 2, wherein the acquiring the authority package currently selected by the video viewer with no membership authority comprises:
acquiring a two-dimensional code selected by the video viewer with no membership authority from the two-dimensional codes corresponding to the plurality of different authority packages for scanning and identifying; and
determining the authority package selected by the video viewer with no membership authority according to the selected two-dimensional code for scanning and identifying.

4. The method according to claim 2, wherein, the corresponding two-dimensional codes generated according to the plurality of different authority packages comprise payment account information of the video viewer with no membership authority.

5. The method according to claim 1, wherein the continuously playing the video content previously previewed by the video viewer with no membership authority according to the message of successful payment for the selected authority package at the background comprises:
Continuously playing video content previously previewed by the video viewer with no membership authority according to a message of successful payment for the selected authority package at a checkout counter on an HTML5 webpage.

6. The method according to claim 1, further comprising: record a time node when playing of the previewed video content is stopped, to continuously play the video content previously previewed by the video viewer with no membership authority at current time.

7. An electronic device, comprising:
at least one processor; and
a memory, communicably connected with the at least one processor and for storing instructions executed by the at least one processor,
wherein execution of the instructions by the at least one processor causes the at least one processor to:
generate a plurality of different authority packages according to video content previewed by a video viewer with no membership authority, and acquire an authority package currently selected by the video viewer with no membership authority; and continuously play previously previewed video content for the video viewer with no membership authority according to a message indicative of successful payment for the selected authority package at the background; and
continuously play video content previously previewed by the video viewer with no membership authority according to a message of successful payment for the selected authority package at the background.

8. The electronic device according to claim 7, wherein the instructions to generate the plurality of different authority packages according to video content previewed by the video viewer with no membership authority cause the at least one processor to:
Generate the plurality of different authority packages according to the video content previewed by the video viewer with no membership authority; and generate corresponding two-dimensional codes according to the plurality of different authority packages.

9. The electronic device according to claim 8, wherein the instructions to acquire the authority package currently selected by the video viewer with no membership authority cause the at least one processor to:
acquire a two-dimensional code selected by the video viewer with no membership authority from the two-dimensional codes corresponding to the plurality of different authority packages for scanning and identifying; and determine the authority package selected by the video viewer with no membership authority according to the selected two-dimensional code for scanning and identifying.

10. The electronic device according to claim 8, wherein the corresponding two-dimensional codes generated according to the plurality of different authority packages comprise payment account information of the video viewer with no membership authority.

11. The electronic device according to claim 7, where in the instructions to continuously play the video content previously previewed by the video viewer with no membership authority according to the message of successful payment for the selected authority package at the background cause the at least one processor to:
continuously play video content previously previewed by the video viewer with no membership authority according to a message of successful payment for the selected authority package at a checkout counter on an HTML5 webpage.

12. The electronic device according to claim 7, wherein the at least one processor is further caused to record a time node when playing of the previewed video content stops, to continuously play the previously previewed video content for the video viewer with no membership authority at current time.

13. A non-transitory computer-readable storage medium storing executable instructions that, when executed by an electronic device with a touch-sensitive display, cause the electronic device to:
generate a plurality of different authority packages according to video content previewed by a video viewer with no membership authority, and acquiring an authority package currently selected by the video viewer with no membership authority; and
continuously play video content for the video viewer with no membership authority according to a message indicative of successful payment for the selected authority package at the background.

14. The non-transitory computer-readable storage medium according to claim 13, wherein the instructions to generate the plurality of different authority packages according to video content previewed by the video viewer with no membership authority cause the electronic device to:
generate the plurality of different authority packages according to the video content previewed by the video viewer with no membership authority; and
generate corresponding two-dimensional codes according to the plurality of different authority packages.

15. The non-transitory computer-readable storage medium according to claim 14, wherein the instructions to acquire the authority package currently selected by the video viewer with no membership authority cause the electronic device to:
acquire a two-dimensional code selected by the video viewer with no membership authority from the two-dimensional codes corresponding to the plurality of different authority packages for scanning and identifying; and
determine the authority package selected by the video viewer with no membership authority according to the selected two-dimensional code for scanning and identifying.

16. The non-transitory computer-readable storage medium according to claim 14, wherein, the corresponding two-dimensional codes generated according to the plurality of different authority packages comprise payment account information of the video viewer with no membership authority.

17. The non-transitory computer-readable storage medium according to claim 13, wherein the instructions to continuously play the video content previously previewed by the video viewer with no membership authority according to the message of successful payment for the selected authority package at the background cause the electronic device to:
continuously play video content previously previewed by the video viewer with no membership authority according to a message of successful payment for the selected authority package at a checkout counter on an HTML5 webpage.

18. The non-transitory computer-readable storage medium according to claim 13, wherein the electronic device is further caused to: record a time node when playing of the previewed video content is stopped, to continuously play the video content previously previewed by the video viewer with no membership authority at current time.
